(19) United States
(12) Patent Application Publication
(10) Pub. No.: US 2026/0314725 A1
(43) Pub. Date: Oct. 15, 2026

(54) HEAD ACCESSORY DEVICE AND METHODS

(71) Applicant: Creagis Innovation LLC, Superior, CO (US)

(72) Inventors: Ellie Hann Hsu, Boulder, CO (US); Jessi Longo, Boulder, CO (US); Ishan Ann Tsay, Boulder, CO (US)

(21) Appl. No.: 19/644,186

(22) Filed: Apr. 10, 2026

Related U.S. Application Data
(60) Provisional application No. 63/788,041, filed on Apr. 13, 2025.

(51) Int. Cl. A41D 20/00; H04R 1/10; H04R 25/00

(52) U.S. Cl. CPC A41D 20/00; H04R 1/105; H04R 25/00

(57) ABSTRACT

Embodiments include a head-worn accessory that lets attached components be positioned where the wearer wants them and then repositioned quickly. A guided sliding interface along the body supports secure placement and smooth adjustment, including for assistive-device components, while keeping attachment structures away from head-contacting areas. As a result, the accessory can remain comfortable and stable during wear, and multiple components can be arranged along the body in a repeatable, user-adjustable manner. Embodiments may also be manufacturable, cost efficient, lightweight, and fashionable. Embodiments may include a head accessory device. The device may include a body. The body may include an interlocking component. The interlocking component may include a groove. The device may include an accessory module. The accessory module may include a protrusion insertable into the groove. The accessory module may be removably coupled to the body by the interlocking component. The accessory module may be slidable along the interlocking component.

### CROSS-REFERENCE TO RELATED APPLICATION

This application claims the benefit of priority to U.S. Provisional Patent Application No. 63/788,041, filed Apr. 13, 2025, the entire contents of which are incorporated herein by reference for all purposes.

### BACKGROUND

Wearable head accessories may include functional items and decorative elements. Attaching items to a head-worn body can create competing constraints: the body should fit comfortably and consistently on a range of head sizes while the attached items should be repositionable, interchangeable, and removable without requiring the body itself to be re-sized, bent, or otherwise altered. Existing approaches frequently rely on fixed mounting locations, bulky clips, or attachment features that press against the wearer or interfere with the fit and comfort of the head-worn body, particularly near regions such as the temples where pressure sensitivity can be high.

Accordingly, there is a need for a head accessory device that provides a robust interface for removably coupling accessory modules to a head-worn body in a manner that permits the modules to be selectively positioned along the body while maintaining wearer comfort. In particular, it is desirable to provide an interlocking interface that supports controlled sliding movement of an attached module relative to the body and that locates the attachment structure on portions of the body that are distal from, or do not bear on, the head-contacting surfaces, thereby reducing the likelihood that the presence, movement, or repositioning of attached modules will alter fit or increase pressure on the wearer.

### BRIEF SUMMARY

The disclosed embodiments provide a head-worn accessory that lets attached components be positioned where the wearer wants them and then repositioned quickly without changing how the head-worn body fits. A guided sliding interface along the body supports secure placement and smooth adjustment, including for assistive-device components, while keeping attachment structures away from head-contacting areas. As a result, the accessory can remain comfortable and stable during wear, and multiple components can be arranged along the body in a repeatable, user-adjustable manner. Embodiments may also be manufacturable, cost efficient, lightweight, and fashionable.

Embodiments may include a head accessory device. The device may include a body. The body may have a first end and a second end. The body may include a linkage portion connecting the first end and the second end. The body may be configured to apply an inward force when resting on a head of a user. The body may include an interlocking component. The interlocking component may include a groove extending along at least a portion of the linkage portion. The device may include an accessory module. The accessory module may include a protrusion insertable into the groove. The accessory module may be removably coupled to the body by the interlocking component. The accessory module may be slidable along the interlocking component while the accessory module is coupled to the body.

Embodiments may include a method of improving hearing. The method may include inserting a hearing aid into a receptacle. The receptacle may be removably coupled to a body of a head accessory device by an interlocking component. The method may include placing the body of the device on a head of the user. The method may further include inserting a receiver of the hearing aid into an ear of the user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a headband 100 according to embodiments of the present invention.

FIG. 2 illustrates an end of a headband according to embodiments of the present invention.

FIG. 3A and FIG. 3B illustrates a configuration for attachment of an accessory module to a headband according to embodiments of the present invention.

FIG. 4 illustrates a headband with two accessory modules according to embodiments of the present invention.

FIG. 5A and FIG. 5B illustrate a hearing aid receptacle according to embodiments of the present invention.

FIG. 6 illustrates a hearing aid receptacle coupled with a headband according to embodiments of the present invention.

FIG. 7A and FIG. 7B illustrates an earplug receptacle according to embodiments of the present invention.

FIG. 8 illustrates a sound localizer according to embodiments of the present invention.

FIG. 9A and FIG. 9B illustrates wearable configurations of the headband and accessory modules according to embodiments of the present invention.

FIG. 10 illustrates a headband being worn according to embodiments of the present invention.

FIG. 11 illustrates a method 1100 according to embodiments of the present invention.

### DETAILED DESCRIPTION

Existing head-worn accessories that carry functional items or decorative elements typically rely on fixed mounting locations, adhesive pads, clamp-style clips, hook-and-loop fasteners, magnets, or other add-on hardware secured to a headband, eyewear frame, or similar body. While these approaches can hold an item in place, they commonly introduce bulk, create pressure points against the wearer, snag hair, or otherwise interfere with comfort, particularly near the temples and behind the ears. Many conventional attachment techniques also concentrate load at discrete points, which can cause the head-worn body to shift during use, deform over time, or become uncomfortable as the wearer moves.

Other existing approaches permit limited repositioning of an attachment by loosening and re-tightening a clamp or by reapplying an adhesive or fastener at a different location. Such repositioning can be inconvenient and may require tools, repeated manipulation, or removal of the head-worn body from the wearer. In addition, attachment structures that wrap around or press into the inner, head-contacting surface can alter the effective geometry of the head-worn body, resulting in inconsistent fit between users and between uses. These drawbacks can be exacerbated when multiple attachments are used on the same head-worn body, as interactions among attachments may further impede comfort and stability.

In one illustrative embodiment, the accessory module carries an assistive device, such as a hearing aid, cochlear implant component, audio processor, microphone, battery pack, controller, or other sensory-assist apparatus, and the module is configured to be removably coupled to the head-worn body and positioned along the body, e.g., aligning the assistive device with a user's ear region. An assistive device, such as a hearing aid, may cause fatigue in the wearer. A hearing aid is designed to be supported by the ear, but the ear may also support or contact other accessories, such as eyeglasses or a hat. The additional weight of the hearing aid may discourage the wearer from using the hearing aid for long periods. By contrast, the present embodiments can support and position an assistive device using a guided sliding interface employed for other accessory modules, enabling adjustment for different users and preferred placements while reducing pressure points and minimizing interference with comfort. Embodiments may also include easy and fast switching between different assistive technology components, such as between a hearing aid and an earplug.

The present embodiments address shortcomings by providing a head-worn body having an interlocking component that defines one or more grooves extending along a portion of the body and by providing accessory modules that include one or more protrusions configured to be slidably received in the groove(s). In this manner, an accessory module can be removably coupled to the head-worn body and selectively positioned along the body by sliding engagement with the groove(s), without requiring adhesives, bulky clamps, or permanent fasteners and without repeated tightening operations. In certain embodiments, the groove(s) are formed on lateral and/or exterior portions of the head-worn body so that the sliding interface is maintained away from the interior, head-contacting surface.

As a result, the accessory modules can be installed, removed, and repositioned along the head-worn body while the body maintains a consistent inward force and fit on the wearer. By locating the coupling interface on portions of the body that do not bear directly on the head and by providing a guided sliding engagement, the present embodiments can reduce pressure points, minimize interference with wearer comfort, and support repeatable placement of one or more accessory modules at selected locations along the head-worn body.

In some embodiments, improvements include reducing perceived weight at the wearer's ear by supporting or redistributing the mass of an assistive device. Improvements may also include enabling quick and straightforward switching between a hearing aid configuration and an earplug configuration. Improvements may further include durability suitable for repeated daily wear over multiple days. Additional features may include supporting sound detection and directional indication to help a wearer determine the direction of a sound source while maintaining an inconspicuous form factor that does not detract from overall appearance. Embodiments may also promote long-term usability by being comfortable and enjoyable to wear.

### Headband

During development, several attachment-interface concepts were evaluated and found to be suboptimal, including knob-based, hole-based, and ridge-based approaches. In the knob-based iterations, protruding knob features were intended to provide discrete mounting points, but the geometry did not reliably mate with the attachments and did not provide a practical coupling mechanism for secure use. In the hole-based iterations, openings were formed in the headband to receive attachment elements, but this insertion-style engagement raised comfort concerns when located near head-contacting regions and also limited design flexibility, including for smaller decorative features, due to the size and placement constraints of the holes.

Ridge-based iterations then attempted to support repositionable attachments by providing a raised feature along the headband, but the ridge geometries created localized pressure and reduced wearer comfort, particularly near temple regions. The ridges may also not provide the desired combination of stable engagement and convenient repositioning. Collectively, these results indicated that discrete protrusions, insertion openings, and simple ridges may each compromise either attachment compatibility or comfort, motivating development toward an interface that supports guided positioning of attachments while maintaining a comfortable headband profile.

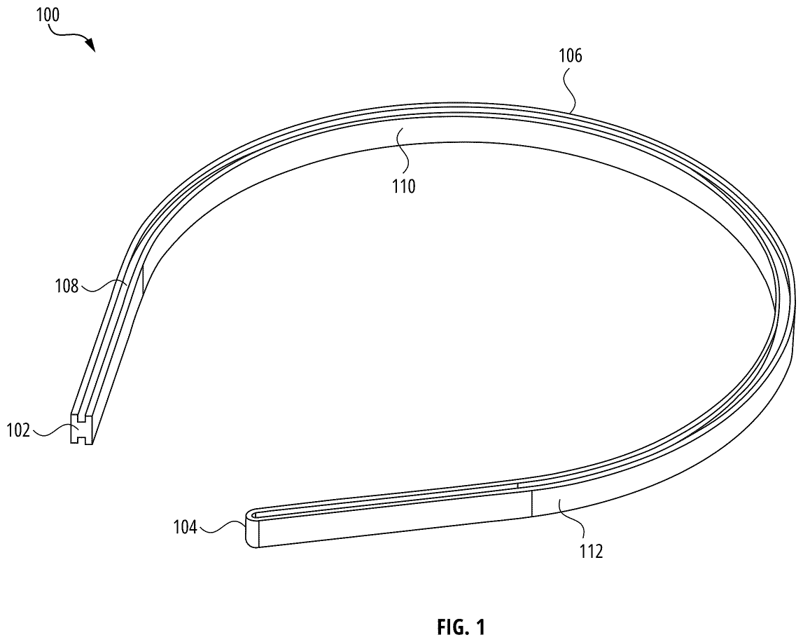

FIG. 1 illustrates a headband 100 including an end 102 and an end 104 connected by a linkage portion 106. The headband 100 includes an interlocking component 108 disposed along at least a portion of the linkage portion 106. In FIG. 1, the interlocking component 108 extends all the way to end 102 on one side. On the other side, the interlocking component 108 is blocked by a stopper at end 104. The stopper prevents movement of an attachment off of end 104. The headband 100 further includes a proximal surface 110 configured to face toward a user's head during wear and a distal surface 112 opposite the proximal surface 110.

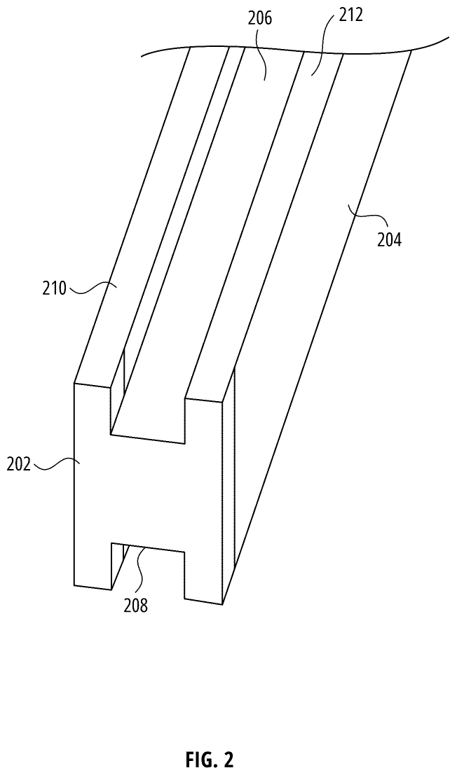

FIG. 2 illustrates a view of an end 202 of the headband 100 of FIG. 1. The end 202 includes a proximal surface 204 configured to face toward a user's head during wear. The headband defines a groove 206 and a groove 208. A rail 210 and a rail 212 are positioned adjacent the grooves 206, 208, respectively, such that the grooves 206, 208 and rails 210, 212 define a track structure along the end 202.

With respect to FIG. 1, the interlocking component 108 may correspond to the track structure implemented by the grooves 206, 208 and the rails 210, 212 (including combinations thereof), which can be configured to slidably and/or removably couple to a receptacle or other attachment via complementary protrusions, trenches, clips, or other engagement features.

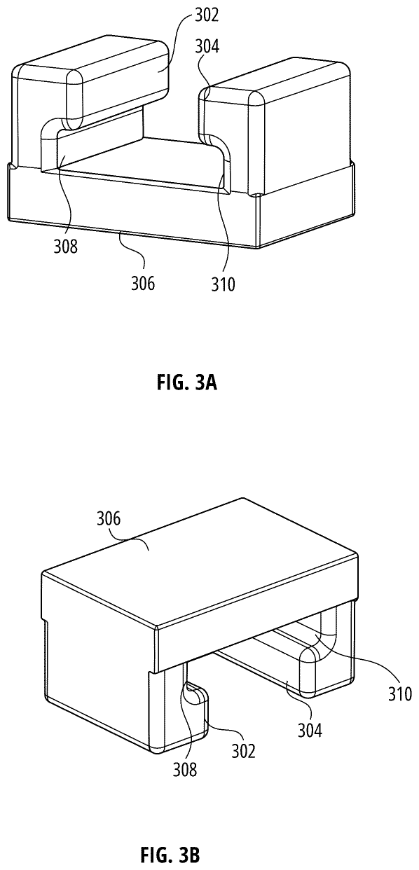

FIG. 3A illustrates an attachment component configured for removable and slidable engagement with the headband 100. The attachment component includes a protrusion 302 and a protrusion 304 extending from a surface 306. The attachment component further defines a channel 308 and a channel 310, which may be configured to receive corresponding rails of the headband 100 while the protrusions 302, 304 are configured to engage corresponding grooves of the headband 100. In some embodiments, surface 306 may be attached to a housing, receptacle, or other component. In some embodiments, surface 306 may be one integrated piece with another component.

FIG. 3B illustrates the attachment component of FIG. 3A in a flipped orientation to show an opposite side of the attachment component relative to FIG. 3A, including the protrusions 302, 304, the surface 306, and the channels 308, 310 as viewed from the flipped orientation.

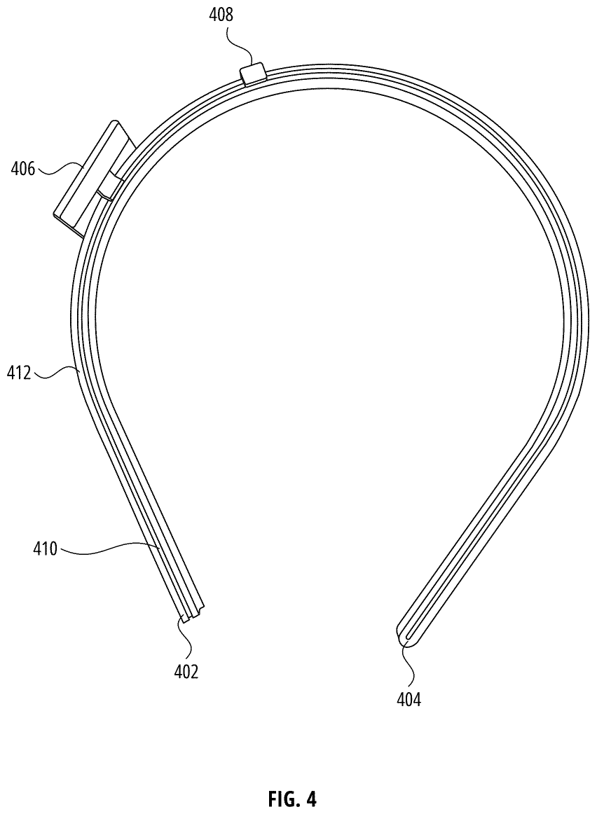

FIG. 4 illustrates a headband having an end 402 and an end 404 with an accessory module 406 and an accessory module 408 engaged with the headband. Each accessory module 406, 408 is a generally planar, flat surface to schematically illustrate engagement with the headband 100 and the ability of the accessory modules 406, 408 to slide along the headband 100 when engaged. In the illustrated example, the headband 100 includes a groove 410 and a rail 412 that define an interlocking track along which one or both accessory modules 406, 408 can be slidably positioned while remaining engaged with the headband. The headband, accessory module 406, and accessory module 408 were produced through additive manufacturing (e.g., 3D printing).

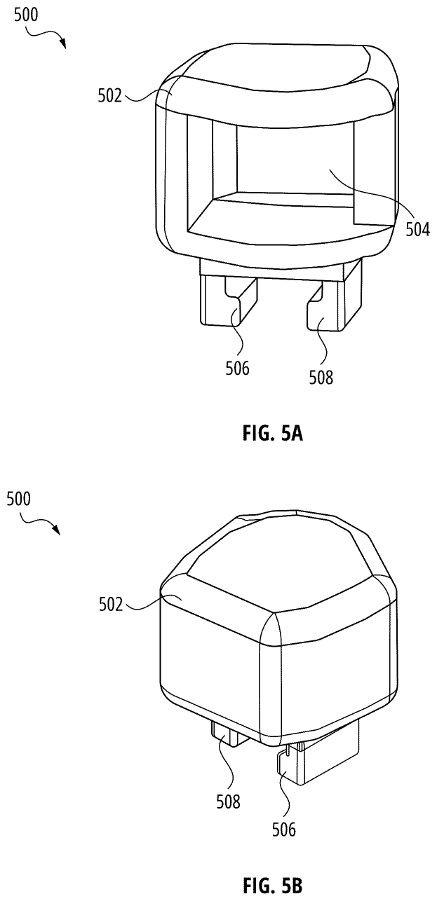

FIG. 5A illustrates a view of a hearing aid receptacle 500 with a top portion facing the viewer. The hearing aid receptacle 500 includes a housing 502 defining an opening 504 at the top portion. The opening 504 is configured to receive a hearing aid inserted generally downward into the opening 504. The hearing aid receptacle 500 further includes a protrusion 506 and a protrusion 508 extending from the housing 502, the protrusions 506, 508 being configured to removably and slidably engage an interlocking component of the headband.

FIG. 5B illustrates the hearing aid receptacle 500 of FIG. 5A in a flipped orientation facing away from the viewer to show a bottom portion of the housing 502, including the protrusions 506, 508 relative to the housing 502.

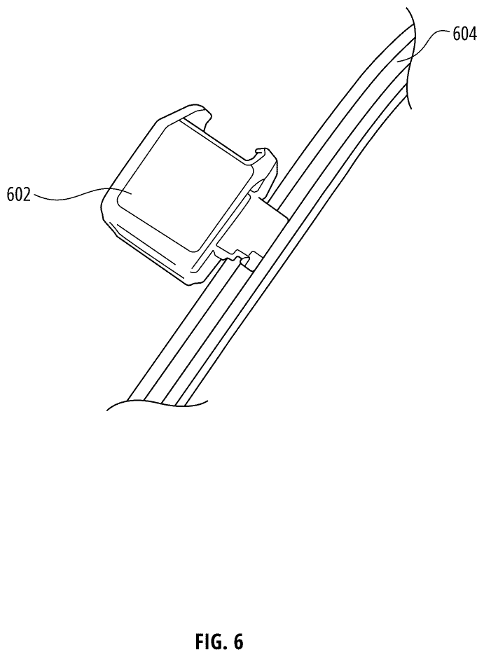

FIG. 6 shows a hearing aid receptacle 602 coupled to a headband with a groove 604. The groove 604 is configured to interface with a complementary interlocking feature of the hearing aid receptacle 602 (e.g., a protrusion) to provide removable attachment and to permit sliding of the hearing aid receptacle 602 along the headband while maintaining engagement. Hearing aid receptacle 602 may be hearing aid receptacle 500 or any hearing aid receptacle described herein.

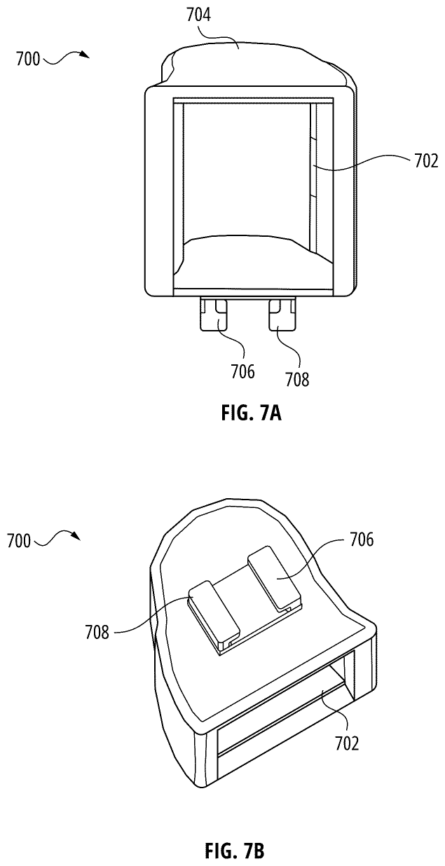

FIG. 7A illustrates a view of an earplug compartment 700 with an opening 702 facing the viewer. An earplug compartment may keep an earplug positioned on the wearable device for rapid switching between a hearing aid and the earplug. An earplug may be needed for a loud-noise activity to address situations where hearing protection is more important than audio awareness. The earplug compartment 700 includes a housing 704 defining the opening 702. Opening 702 may be configured to receive an earplug inserted into the housing 704.

FIG. 7B illustrates the earplug compartment 700 in another orientation relative to FIG. 7A to show a first protrusion 706 and a second protrusion 708 extending from the housing 704. The protrusions 706, 708 are configured to complement a rail-and-groove interlocking system of the headband 100 such that the earplug compartment 700 can be removably coupled to and slid along the headband 100 while maintaining engagement.

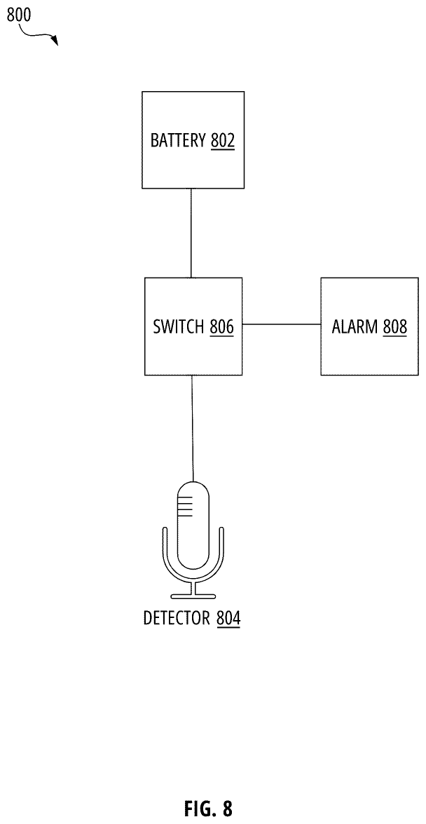

FIG. 8 illustrates a functional block representation of a sound localizer 800. FIG. 8 is not a circuit diagram. The sound localizer 800 includes a battery 802, a detector 804, a switch 806, and an alarm 808. The battery 802 provides electrical power to one or more components of the sound localizer 800. The detector 804 is configured to detect an acoustic condition (for example, sound presence, sound level above a threshold, and/or a direction of arrival) and to generate a control signal based on the detected acoustic condition. The switch 806 may be configured to selectively enable, disable, and/or modulate delivery of power and/or a drive signal to the alarm 808 based on the signal from the detector 804.

The switch 806 can be implemented using, for example, a mechanical switch, a relay, or a solid-state switch such as a MOSFET, a bipolar junction transistor, and/or an integrated analog switch. In some implementations, the switch 806 may be controlled by a controller (e.g., a microcontroller) that is included in the detector 804 and/or otherwise included in the sound localizer 800 but not shown.

The alarm 808 can include, for example, a visual indicator (e.g., an LED or other light source) and/or a haptic indicator (e.g., a vibration motor or linear resonant actuator).

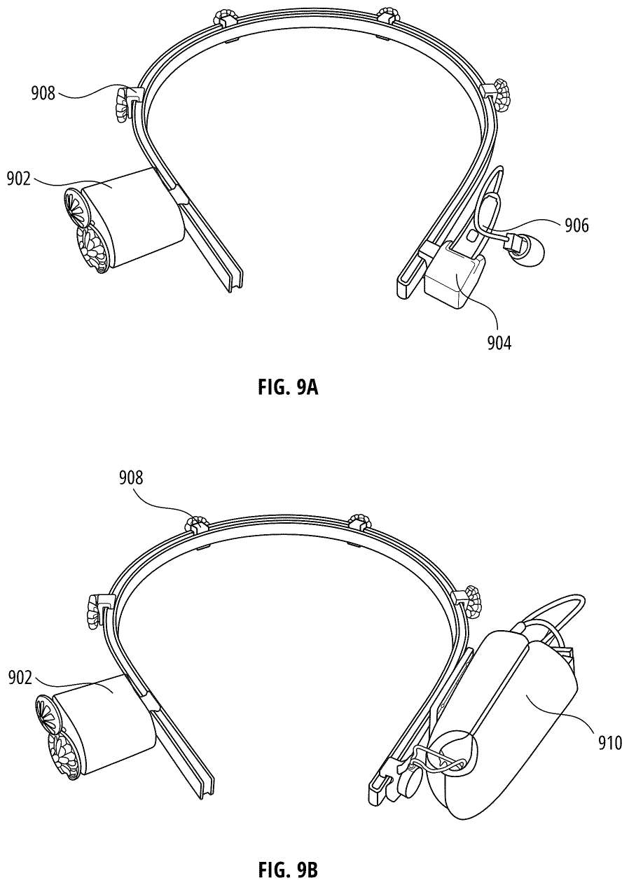

FIG. 9A illustrates an example configuration of a wearable assembly including an earplug compartment 902 and a hearing aid receptacle 904 coupled to a headband (e.g., headband 100). In the illustrated configuration, a hearing aid 906 is received within the hearing aid receptacle 904. Decorative attachments (e.g., decorative attachment 908) are also coupled to the headband to provide an ornamental and/or aesthetic feature. The earplug compartment 902, hearing aid receptacle 904, and decorative attachment 908 may remain positionable along the headband.

FIG. 9B illustrates another example configuration of a wearable assembly including an earplug compartment 902 and a decorative attachment 908 coupled to a headband (e.g., headband 100). In the illustrated configuration, a sound localizer 910 is coupled to the headband to provide a sound-detection and user-notification function. The earplug compartment 902, decorative attachment 908, and sound localizer 910 may remain positionable along the headband.

In FIG. 9B, the hearing aid receptacle 904 is replaced by sound localizer 910. The wearer may be concerned with the directionality of a sound, which may not be captured as cleanly by a hearing aid among ambient noise.

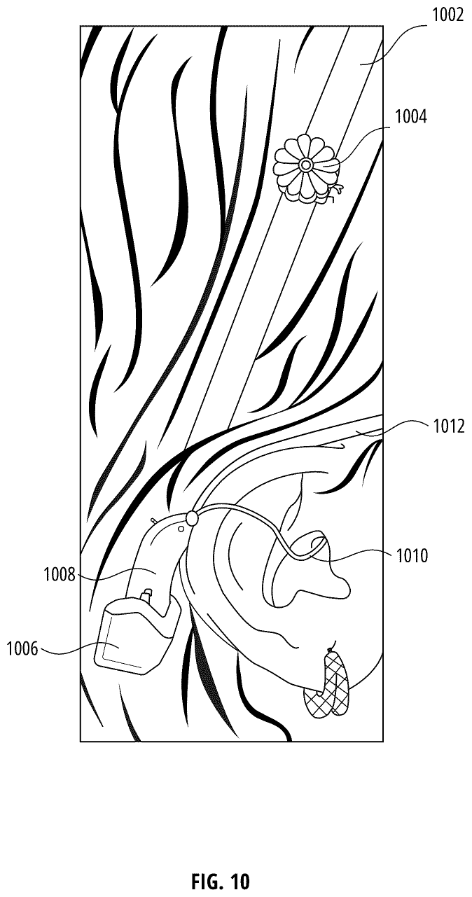

FIG. 10 shows a headband 1002 being worn by a user. Headband 1002 includes a decorative attachment 1004 and a hearing aid receptacle 1006. A hearing aid 1008 is disposed within hearing aid receptacle 1006. The receiver 1010 is positioned within the user's ear. In this configuration, no weight is on the ear from the hearing aid, and no contact other than incidental contact is made between the battery housing and earhook and the user's ear. Additionally, the user can wear eyeglasses, as illustrated by glasses frame 1012, while wearing the headband 1002 and using hearing aid 1008.

### Example Systems

Embodiments may include a head accessory device. The device may include a body and an accessory module. For example, the body may be headband 100 or headband 1002. The accessory module may be a hearing aid receptacle, such as hearing aid receptacle 500, hearing aid receptacle 602, hearing aid receptacle 904, or hearing aid receptacle 1006, an earplug compartment such as earplug compartment 700 or earplug compartment 902, a sound localizer such as sound localizer 800 or sound localizer 910, a decorative attachment such as decorative attachment 908 or decorative attachment 1004, and/or another accessory module such as accessory module 406 or accessory module 408.

The body may have a first end and a second end. The body may include a linkage portion connecting the first end and the second end. The linkage portion may be an arch. As used herein, an “arch” includes a curved or bowed portion extending between the first end and the second end and configured to span across a head region during wear. The arch may have a non-constant curvature, and the arch may include one or more substantially straight segments connected by one or more curved segments such that the linkage portion overall defines an arch-like profile when viewed from the front or top. In some embodiments, the arch is headband-shaped rather than a true geometric arch and includes a generally arcuate form that follows a contour of the wearer's head while providing a resilient bias that urges the first end and the second end inward during wear. The body may be configured to apply an inward force when resting on a head of a user or wearer. The body may be configured such that the first end and the second end may not be the most laterally outward parts of the body. The body may be a headband, including headband 100 or any headband described herein. As an example, the body may be a headband configured to be worn across the top of the head from one ear to the other ear. The headband may be positioned behind each ear.

In some embodiments, the body may be a headband configured to be worn across the forehead and extend at least from one ear to the other ear. The headband may be positioned above each year.

The body may be at least a part of an eyeglass frame. The body may include the portion of the eyeglass frame from the portion that contacts the ear to the lens (e.g., near the temple).

The body may include an interlocking component. The interlocking component may include a groove extending along at least a portion of the linkage portion. The interlocking component may extend from the first end to the second end across the entirety of the linkage portion. The interlocking component may include a first rail and a second rail extending along the linkage portion. The groove may be disposed between the first rail and the second rail. In some embodiments, the groove may be considered a trench or channel. The body may have a cross section that resembles an I-beam.

The interlocking component may extend to a terminus of the first end. For example, the first end may be end 102, where the groove and rail extend to the terminus of the first end. In some embodiments, the interlocking component may not extend to a terminus of the second end such that the receptacle is not slidable past the second end. For example, the second end may be end 104, where the groove terminates. The second end may have a stopper or end stop or cap that prevents sliding past the end. In some embodiments, at least one of the first end or the second end may have a cap or stopper to prevent sliding past the end during some times, while also being removable to slide on another accessory module.

The accessory module may include a protrusion insertable into the groove. The accessory module may be removably coupled to the body by the interlocking component. The accessory module may be slidable along the interlocking component while the accessory module is coupled to the body. In some embodiments, the protrusion may be considered a tongue for a tongue-in-groove system with the groove of the interlocking component. The accessory module may not contact the user when the accessory module is coupled to the body. In some embodiments, the portion of the accessory module that interfaces with the interlocking component may be referred to as a bracket, clip, clamp, coupler, carriage, slider, rail-interface, track-interface, and/or clip interface.

In some embodiments, the groove may be a first groove. The protrusion may be a first protrusion. The body may include an interior surface proximal to the head during wear. The body may include an exterior surface distal to the head during wear. The body may include a first lateral surface and a second lateral surface. The first lateral surface may define the first groove. The second lateral surface may define a second groove. The first protrusion may be insertable into the first groove. The accessory module may include a second protrusion insertable into the second groove while the first protrusion is inserted into the first groove. In some embodiments, the first lateral surface and the second lateral surface are perpendicular to the interior surface.

In some embodiments, the groove in the body is defined by and bordered by one or more rails. The protrusions of the accessory module may define channels (e.g., channel 308 and channel 310). The channels may be shaped complementary to the rails to allow sliding and interlocking. In some embodiments, the protrusion may include a clip interface defining a U-shaped channel. The U-shaped channel may be configured to receive at least a portion of a rail of the body.

In some embodiments, the body may include an exterior surface distal to the head during wear. The exterior surface may define the groove. For example, the groove may not be on the lateral surfaces of the body. As another example, the body may have a cross section similar to the accessory module illustrated in FIG. 3A. The groove is defined by two protrusions and includes the channels defined by the protrusions. The accessory modules may include a T-shaped tongue configured to interface with the channel.

In some embodiments, the interlocking component may be implemented as a dovetail track and complementary dovetail slide, a T-slot track and complementary T-shaped coupler, a C-channel or keyhole slot and a complementary bead or stud that slides in the channel, a snap-fit track that provides sliding while allowing removal via elastic deflection, a detent-and-groove system that provides indexed positions along the body, and/or a clamp-style interface that grips a rib or edge of the body. In some embodiments, the interlocking system may include a magnetic interface, optionally combined with a mechanical guide such as rails to resist lateral shear. In some embodiments, the interlocking system may further include a lock feature such as a set screw, cam lock, latch, and/or friction pad configured to selectively inhibit sliding after the accessory module is positioned.

The accessory module may be a receptacle. The receptacle may define an opening configured to accept a hearing aid. In some embodiments, the opening may define a cavity having one or more interior surfaces shaped to conform to an exterior surface of a hearing aid housing, including a contoured floor, tapered sidewalls, and/or one or more retention features such as a lip, ridge, undercut, compliant finger, strap, door, and/or elastic band configured to inhibit unintentional removal while permitting insertion and removal by a user. In some embodiments, the receptacle may include a compliant liner such as an elastomeric pad and/or one or more interchangeable inserts to accommodate different hearing aid form factors without modification of the receptacle. In some embodiments, the receptacle may define a clearance slot, notch, and/or aperture configured to permit passage of an earhook, wire, and/or receiver lead while the hearing aid housing remains supported by the receptacle. The opening may be configured such that a battery housing of the hearing aid is disposed in the receptacle. The earhook and/or the receiver of the hearing aid may be disposed outside of the receptacle. The receptacle may be configured so that the receiver is disposed in the ear of the wearer without the weight of the hearing aid or any other part of the hearing aid supported by the wearer's ear.

The device may include a second receptacle for a second hearing aid. The second receptacle may be a mirror image of the first receptacle so that the hearing aid receptacles are on both sides of the body. In some embodiments, the device may include the hearing aid or two hearing aids.

In some embodiments, the device may further include a compartment. The compartment may be configured to accept an earplug or two earplugs. The compartment may include a protrusion insertable into the groove. In some embodiments, the device may include an earplug. In some embodiments, an earplug compartment may include one or more retention features configured to inhibit unintentional removal of an earplug during user motion, including bending, head rotation, and/or inversion, while permitting manual removal.

In some embodiments, the accessory module may function as an earplug. The accessory module may slide along the body so that an earplug extending from the body can be inserted into an ear. The earplug may be coupled to the protrusion interfacing with the interlocking component by an extendable or adjustable arm. The earplug may be moved vertically or closer to the body when not in use. In some embodiments, the extendable or adjustable arm may be implemented as a telescoping arm, a hinged arm with one or more pivot joints, a flexible arm configured to bias the earplug toward an insertion position, a sliding post that translates relative to the accessory module, and/or an arm having a detent or ratchet configured to hold one of multiple extension lengths. In some embodiments, the earplug may be rotatable about one or more axes to accommodate different ear angles, and the arm may be configured to move the earplug between a stowed position and an in-use position.

In some embodiments, the accessory module may include an audio sensor. The audio sensor may be sound localizer 800, sound localizer 910, or any similar device described herein. The audio sensor may include a sound detector. The audio sensor may include an alarm in electrical communication with the sound detector. The alarm may be configured to trigger when the sound detector detects a sound having a threshold volume. The alarm may be a haptic device or a light (e.g., LED). The audio sensor may be directional because the audio sensor is placed on one side of the body. When a sound with a threshold volume is detected, the alarm indicates the side (e.g., left or right) of the origin of the sound because of the placement of the audio sensor. For example, the audio sensor may include a battery configured to power a detector, a switch, and an alarm, where the detector is configured to detect an acoustic condition and output a control signal, and where the switch selectively enables, disables, and/or modulates delivery of power and/or a drive signal to the alarm based on the control signal. In some embodiments, the switch may be implemented as a mechanical switch, relay, and/or solid-state switch such as a MOSFET, bipolar junction transistor, and/or integrated analog switch, and the alarm may include a light source and/or a haptic indicator such as a vibration motor and/or linear resonant actuator. In some embodiments, directionality can be achieved by mounting the audio sensor on one side of the headband such that the alarm indicates which side of the wearer is nearer the sound source, and directionality can be improved using two audio sensors on opposite sides of the body with comparative thresholding and/or time-of-arrival processing.

In some embodiments, the device may include one or more decorative attachments removably coupled to the body by the interlocking component. For example, a decorative attachment may include an ornamental element such as beads, charms, a figurine, a logo plate, and/or a patterned panel secured to a platform or bracket that is slidably engaged with the interlocking component. In some embodiments, multiple decorative attachments may be simultaneously coupled to the body and independently repositioned along the body to adjust aesthetics and spacing relative to other accessory modules. In some embodiments, a decorative attachment may further include a functional feature, such as a reflective element, a light, and/or a protective cover for an electronic component.

In some embodiments, the body and/or the accessory module may be produced by additive manufacturing (e.g., 3D printing). In some embodiments, the body and/or the accessory module may include urethane dimethacrylate (UDMA), ethoxylated bisphenol A dimethacrylate (Bis-EMA), trimethylolpropane triacrylate (TMPTA), polyethylene glycol diacrylate (PEGDA), methyl methacrylate (MMA), hydroxyethyl methacrylate (HEMA), epoxy acrylate oligomers, cycloaliphatic epoxy resins, aliphatic urethane acrylates, aromatic urethane acrylates, siloxane-modified acrylates, thermoplastic polyurethane, polylactic acid, or photoinitiators such as diphenyl(2,4,6-trimethylbenzoyl)phosphine oxide (TPO), 2-hydroxy-2-methylpropiophenone, or Irgacure 819. In some embodiments, the body and/or the accessory module may additionally or alternatively include acrylonitrile butadiene styrene (ABS), polyethylene terephthalate glycol (PETG), polyamide, polycarbonate, polypropylene, polyurethane elastomers, glass-filled polymers, carbon-fiber-reinforced polymers, silicone-like photopolymers, and/or stereolithography resins formulated for toughness and/or flexibility.

In some embodiments, the body and/or the accessory module may be produced by injection molding, overmolding, extrusion followed by cutting and forming, thermoforming, compression molding, machining, stamping, and/or bending. In some embodiments, multiple parts can be produced separately and assembled using fasteners, ultrasonic welding, solvent welding, heat staking, press fits, adhesives, and/or snap-fit joints.

In some embodiments, the body and/or accessory modules may include metal, such as aluminum, stainless steel, spring steel, titanium, nickel-titanium, brass, and/or copper alloys. Metal components may be manufactured by stamping and forming, laser cutting, wire forming, CNC machining, die casting, metal injection molding, and/or metal additive manufacturing. In some embodiments, metal components may be surface-treated, for example anodizing, passivation, powder coating, plating, polishing, and/or applying a low-friction coating, to improve corrosion resistance, comfort, and/or sliding performance at the interlocking interface.

Example dimensions are provided. For the body, the width of the groove may be 1.964 mm. The width of the groove may be in a range from 1.0 to 1.5 mm, 1.5 to 1.7 mm, 1.7 to 1.9 mm, 1.9 to 2.0 mm, 2.0 to 2.1 mm, 2.1 to 2.3 mm, 2.3 to 2.5 mm, or over 2.5 mm. The height of the body may be 6.5 mm. The height of the body may be in a range from 3.0 to 4.5 mm, 4.5 to 5.5 mm, 5.5 to 6.5 mm, 6.5 to 7.5 mm, 7.5 to 9.0 mm, 9.0 to 12.0 mm, or over 12.0 mm. The height of the rail or the groove may be 1.5 mm. The height of the rail or the groove may be in a range from 0.5 to 1.0 mm, 1.0 to 1.2 mm, 1.2 to 1.4 mm, 1.4 to 1.6 mm, 1.6 to 2.0 mm, 2.0 to 3.0 mm, or over 3.0 mm. The width of the rail may be 1 mm. The width of the rail may be in a range from 0.3 to 0.6 mm, 0.6 to 0.8 mm, 0.8 to 1.0 mm, 1.0 to 1.2 mm, 1.2 to 1.6 mm, 1.6 to 2.5 mm, or over 2.5 mm. The width of the body may be 3.965 mm. The width of the body may be in a range from 2.0 to 3.0 mm, 3.0 to 3.5 mm, 3.5 to 4.0 mm, 4.0 to 4.5 mm, 4.5 to 5.5 mm, 5.5 to 7.5 mm, or over 7.5 mm. The length of the proximal portion of the body may be 375.443 mm. The length of the proximal portion may be in a range from 250 to 320 mm, 320 to 350 mm, 350 to 370 mm, 370 to 390 mm, 390 to 420 mm, 420 to 480 mm, or over 480 mm. The length of the distal portion of the body may be 392.492 mm. The length of the distal portion may be in a range from 250 to 330 mm, 330 to 360 mm, 360 to 385 mm, 385 to 410 mm, 410 to 450 mm, 450 to 520 mm, or over 520 mm.

For the hearing aid receptacle, the width of the housing may be 154.685 mm. The width of the housing may be in a range from 80 to 120 mm, 120 to 140 mm, 140 to 150 mm, 150 to 160 mm, 160 to 180 mm, 180 to 220 mm, or over 220 mm. The distance between front and back may be 102.858 mm. The distance between front and back may be in a range from 50 to 80 mm, 80 to 90 mm, 90 to 100 mm, 100 to 110 mm, 110 to 140 mm, 140 to 180 mm, or over 180 mm. The front may be shorter than the back or vice versa. The height of the short side may be 77.542 mm. The height of the short side may be in a range from 40 to 60 mm, 60 to 70 mm, 70 to 80 mm, 80 to 90 mm, 90 to 120 mm, 120 to 160 mm, or over 160 mm. The height of the tall side may be 107.684 mm. The height of the tall side may be in a range from 60 to 85 mm, 85 to 100 mm, 100 to 110 mm, 110 to 125 mm, 125 to 160 mm, 160 to 220 mm, or over 220 mm. The height of the sides parallel to the headband may be 138.389 mm. The height of the sides parallel to the headband may be in a range from 80 to 110 mm, 110 to 130 mm, 130 to 145 mm, 145 to 165 mm, 165 to 220 mm, 220 to 300 mm, or over 300 mm. The thickness of the sides may be 25.66 mm. The thickness of the sides may be in a range from 5 to 15 mm, 15 to 20 mm, 20 to 25 mm, 25 to 30 mm, 30 to 45 mm, 45 to 70 mm, or over 70 mm. The length of the bracket may be 89.489 mm. The length of the bracket may be in a range from 30 to 60 mm, 60 to 80 mm, 80 to 90 mm, 90 to 105 mm, 105 to 140 mm, 140 to 220 mm, or over 220 mm. The height of the bracket may be 45.557 mm. The height of the bracket may be in a range from 20 to 35 mm, 35 to 45 mm, 45 to 55 mm, 55 to 70 mm, 70 to 110 mm, 110 to 180 mm, or over 180 mm. The width of the bracket may be 56.952 mm. The width of the bracket may be in a range from 20 to 40 mm, 40 to 50 mm, 50 to 60 mm, 60 to 80 mm, 80 to 120 mm, 120 to 200 mm, or over 200 mm. An opening volume may be from 0.5 to 1.0 cm³, 1.0 to 1.5 cm³, 1.5 to 2.0 cm³, 2.0 to 3.0 cm³, 3.0 to 5.0 cm³, or greater than 5.0 cm³.

For the earplug compartment, the height of side contacting the bracket may be 187.316 mm. The height of the side contacting the bracket may be in a range from 100 to 150 mm, 150 to 170 mm, 170 to 180 mm, 180 to 190 mm, 190 to 220 mm, 220 to 300 mm, or over 300 mm. The height of the side without the bracket may be 186.983 mm. The height of the side without the bracket may be in a range from 100 to 150 mm, 150 to 170 mm, 170 to 180 mm, 180 to 190 mm, 190 to 220 mm, 220 to 300 mm, or over 300 mm. The height of the short side may be 164.469 mm. The height of the short side may be in a range from 80 to 120 mm, 120 to 150 mm, 150 to 170 mm, 170 to 190 mm, 190 to 240 mm, 240 to 320 mm, or over 320 mm. The height of the long side may be 171.247 mm. The height of the long side may be in a range from 80 to 130 mm, 130 to 155 mm, 155 to 175 mm, 175 to 195 mm, 195 to 250 mm, 250 to 340 mm, or over 340 mm. The maximum distance between short and tall sides may be 201.658 mm. The maximum distance between short and tall sides may be in a range from 120 to 160 mm, 160 to 185 mm, 185 to 205 mm, 205 to 230 mm, 230 to 300 mm, 300 to 450 mm, or over 450 mm. The maximum distance between the other sides may be 163.992 mm. The maximum distance between the other sides may be in a range from 90 to 130 mm, 130 to 150 mm, 150 to 170 mm, 170 to 200 mm, 200 to 280 mm, 280 to 420 mm, or over 420 mm. The thickness of the sides may be 2.0 mm. The thickness of the sides may be in a range from 0.5 to 1.0 mm, 1.0 to 1.5 mm, 1.5 to 2.0 mm, 2.0 to 2.5 mm, 2.5 to 4.0 mm, 4.0 to 8.0 mm, or over 8.0 mm. An opening volume may be from 0.5 to 1.0 cm³, 1.0 to 1.5 cm³, 1.5 to 2.0 cm³, 2.0 to 3.0 cm³, 3.0 to 5.0 cm³, 5.0 to 7.0 cm³, 7.0 to 10 cm³, or greater than 10 cm³.

For the bracket, the height may be 5.00 mm. The height may be in a range from 2.0 to 3.5 mm, 3.5 to 4.5 mm, 4.5 to 5.5 mm, 5.5 to 6.5 mm, 6.5 to 8.5 mm, 8.5 to 12.0 mm, or over 12.0 mm. The length of the flat part of the bracket may be 9.70 mm. The length of the flat part may be in a range from 5.0 to 7.0 mm, 7.0 to 9.0 mm, 9.0 to 10.5 mm, 10.5 to 13.0 mm, 13.0 to 18.0 mm, 18.0 to 30.0 mm, or over 30.0 mm. The width of the flat part of the bracket may be 6.50 mm. The width of the flat part may be in a range from 3.0 to 5.0 mm, 5.0 to 6.0 mm, 6.0 to 7.0 mm, 7.0 to 9.0 mm, 9.0 to 14.0 mm, 14.0 to 25.0 mm, or over 25.0 mm. The closest distance between the protrusions may be 4.50 mm. The closest distance between the protrusions may be in a range from 2.0 to 3.0 mm, 3.0 to 4.0 mm, 4.0 to 5.0 mm, 5.0 to 6.5 mm, 6.5 to 9.0 mm, 9.0 to 15.0 mm, or over 15.0 mm. The distance between the channels associated with the protrusions may be 6.50 mm. The distance between the channels may be in a range from 3.5 to 5.5 mm, 5.5 to 6.0 mm, 6.0 to 7.0 mm, 7.0 to 9.0 mm, 9.0 to 13.0 mm, 13.0 to 22.0 mm, or over 22.0 mm. The width of a bracket may be 2.50 mm. The width of a bracket may be in a range from 1.0 to 1.8 mm, 1.8 to 2.3 mm, 2.3 to 2.7 mm, 2.7 to 3.5 mm, 3.5 to 5.5 mm, 5.5 to 10.0 mm, or over 10.0 mm. The thickness of the flat part of the bracket may be 2.00 mm. The thickness of the flat part may be in a range from 0.8 to 1.2 mm, 1.2 to 1.6 mm, 1.6 to 2.2 mm, 2.2 to 3.0 mm, 3.0 to 4.5 mm, 4.5 to 8.0 mm, or over 8.0 mm.

In some embodiments, the body may include a comfort layer, such as a silicone pad, foam strip, textile sleeve, and/or low-friction coating on a head-contacting surface, and the interlocking component may be positioned on a non-contacting surface to reduce hair snagging and pressure points. In some embodiments, the accessory module may include a housing that encloses electronics, such as a detector, battery, and alarm within a pouch or enclosure that is removably secured to a platform coupled to the interlocking component.

### Example Methods

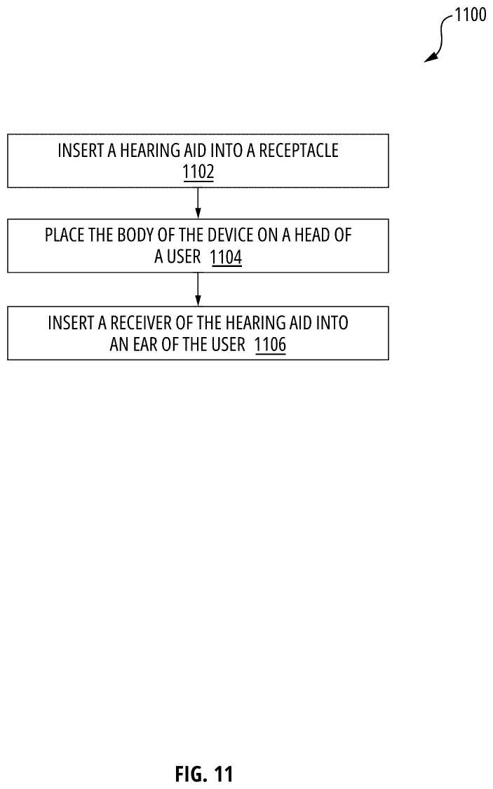

FIG. 11 shows a method 1100 of improving hearing or audio awareness. All or parts of method 1100 may be performed while the body is worn on the head or prior to donning the body.

In block 1102, method 1100 inserts a hearing aid into a receptacle. The receptacle may be removably coupled to a body of a head accessory device by an interlocking component. The head accessory device may be any head accessory device described herein. In some embodiments, block 1102 further includes coupling the receptacle to the body by inserting one or more protrusions of the receptacle into one or more grooves of the body and sliding the receptacle into engagement along the interlocking component. In some embodiments, coupling the receptacle to the body includes removing an end cap or stopper from an end of the body, sliding the receptacle onto the interlocking component, and reinstalling the end cap or stopper to inhibit sliding off the end. In some embodiments, block 1102 includes securing the hearing aid within the receptacle using a retention feature, such as a lip, ridge, strap, door, latch, and/or compliant liner, while leaving an earhook, wire, and/or receiver lead extending out of the receptacle through a clearance slot, notch, and/or aperture.

In block 1104, method 1100 places the body of the device on a head of the user. Method 1100 may include sliding the receptacle along the body to position the receiver of the hearing aid for insertion into the ear. In some embodiments, block 1104 includes orienting the body such that a comfort layer contacts a head-contacting surface of the body while the interlocking component is positioned on a non-contacting surface to reduce hair snagging and pressure points during sliding adjustment. In some embodiments, block 1104 includes sliding the receptacle while the body remains on the head to align the receptacle with an ear region of the user, and then inhibiting further sliding using a lock feature, such as a detent, friction interface, latch, cam lock, and/or set screw. In some embodiments, block 1104 includes positioning one or more additional accessory modules on the body, repositioning the accessory modules relative to each other, and/or repositioning a decorative attachment to avoid interference with another accessory module. In some embodiments, block 1104 further includes donning eyeglasses while the body is worn and adjusting a position of the receptacle along the body to reduce interference with a temple portion of the eyeglasses.

In block 1106, method 1100 inserts a receiver of the hearing aid into an ear of the user. In some embodiments, the weight of the hearing aid is not directly on the ear. In some embodiments, block 1106 includes routing the receiver lead and/or earhook to reduce contact between a housing portion of the hearing aid and the user's ear. In some embodiments, block 1106 includes verifying that the receptacle supports at least a portion of the hearing aid mass such that contact between the hearing aid housing and the ear is incidental during wear.

In some embodiments, method 1100 may include positioning an accessory module on the body. The accessory module may be any accessory module described herein. The accessory module may include an earplug module. Method 1100 may include positioning the earplug module near the ear and then inserting the earplug of the earplug module into the ear. In some embodiments, method 1100 further includes switching between a hearing-aid configuration and an earplug configuration by removing the receiver from the ear, sliding the receptacle away from the ear region, positioning an earplug module proximate the ear, and inserting the earplug into the ear. In some embodiments, switching includes removing the hearing aid from the receptacle and storing the hearing aid in a compartment, and/or storing the earplug in an earplug compartment when the earplug is not in use. In some embodiments, the earplug module includes an adjustable arm, and method 1100 includes moving the earplug between a stowed position and an in-use position by translating and/or rotating the adjustable arm relative to the body.

In some embodiments, method 1100 further includes positioning an audio sensor module on the body and detecting a sound having a threshold volume, and the method further includes actuating an alarm to provide a directional indication based on a placement of the audio sensor module on a first side of the body. In some embodiments, the method includes adjusting the threshold volume, enabling or disabling the alarm, selecting an alarm modality including a haptic indication and/or a light indication, and/or positioning a second audio sensor module on an opposite side of the body to improve directional discrimination. In some embodiments, the audio sensor module is enclosed in a pouch or enclosure removably secured to a platform coupled to the interlocking component.

In some embodiments, method 1100 further includes removing an accessory module from the body by sliding the accessory module toward an end of the body and disengaging the protrusion from the groove, and then installing a different accessory module by engaging a protrusion of the different accessory module with the groove and sliding the different accessory module to a selected position. In some embodiments, method 1100 further includes cleaning and/or replacing a comfort layer, a liner, and/or another user-contacting component of the body and/or accessory module between uses.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

Any dimension described herein discloses a range of up to ±50% of the dimension. For example, if 10 mm is the dimension, a range from 5 to 15 mm is disclosed.

Where a range of values is disclosed/provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

The term “about” or “approximately” can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term “about” or “approximately” can mean within an order of magnitude, within 5-fold, and more preferably within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%. Any exact number described herein may be modified with “about” or “approximately.”

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

What is claimed is:

1. A head accessory device, the device comprising:
a body, wherein:
the body has a first end and a second end,
the body comprises a linkage portion connecting the first end and the second end,
the body is configured to apply an inward force when resting on a head of a user, and
the body comprises an interlocking component, wherein the interlocking component comprises a groove extending along at least a portion of the linkage portion; and
an accessory module, wherein:
the accessory module comprises a protrusion insertable into the groove,
the accessory module is removably coupled to the body by the interlocking component, and
the accessory module is slidable along the interlocking component while the accessory module is coupled to the body.

2. The device of claim 1, wherein:
the accessory module is a receptacle, and
the receptacle defines an opening configured to accept a hearing aid.

3. The device of claim 2, wherein:
the opening is configured such that:
a battery housing of the hearing aid is disposed in the receptacle, and
an earhook and a receiver of the hearing aid are disposed outside of the receptacle.

4. The device of claim 1, wherein:
the groove is a first groove,
the protrusion is a first protrusion,
the body comprises an interior surface proximal to the head during wear,
the body comprises an exterior surface distal to the head during wear,
the body comprises a first lateral surface and a second lateral surface,
the first lateral surface defines the first groove,
the second lateral surface defines a second groove,
the first protrusion is insertable into the first groove, and
the accessory module comprises a second protrusion insertable into the second groove while the first protrusion is inserted into the first groove.

5. The device of claim 4, wherein the first lateral surface and the second lateral surface are perpendicular to the interior surface.

6. The device of claim 1, wherein:
the body comprises an exterior surface distal to the head during wear, and
the exterior surface defines the groove.

7. The device of claim 1, wherein the protrusion is a first protrusion,
the device further comprising a compartment, wherein:
the compartment is configured to accept an earplug, and
the compartment comprises a second protrusion insertable into the groove.

8. The device of claim 1, wherein the accessory module comprises an audio sensor, wherein:
the audio sensor comprises a sound detector,
the audio sensor comprises an alarm in electrical communication with the sound detector, and
the alarm is configured to trigger when the sound detector detects a sound having a threshold volume.

9. The device of claim 8, wherein the alarm is a haptic device or a light.

10. The device of claim 1, wherein the interlocking component extends from the first end to the second end across an entirety of the linkage portion.

11. The device of claim 1, wherein the body is a headband.

12. The device of claim 1, wherein the body is an eyeglass frame.

13. The device of claim 1, wherein the interlocking component extends to a terminus of the first end.

14. The device of claim 13, wherein the interlocking component does not extend to a terminus of the second end such that the accessory module is not slidable past the second end.

15. The device of claim 1, wherein the body and the accessory module are produced by additive manufacturing.

16. The device of claim 1, wherein:
the interlocking component comprises a first rail and a second rail extending along the linkage portion, and
the groove is disposed between the first rail and the second rail.

17. The device of claim 16, wherein:
the protrusion comprises a clip interface defining a U-shaped channel, and
the U-shaped channel is configured to receive at least a portion of the first rail or the second rail.

18. The device of claim 1, further comprising one or more decorative attachments slidably engaged to the interlocking component.

19. A method of improving hearing, the method comprising:
inserting a hearing aid into a receptacle, wherein:
the receptacle is removably coupled to a body of a head accessory device by an interlocking component;
placing the body of the device on a head of a user; and
inserting a receiver of the hearing aid into an ear of the user.

20. The method of claim 19, further comprising:
sliding the receptacle along the body to position the receiver of the hearing aid for insertion into the ear.
